(19) United States
(12) Patent Application Publication
(10) Pub. No.: US 2021/0263594 A1
(43) Pub. Date: Aug. 26, 2021

(54) INPUT DEVICES WITH DETACHABLE INPUT DEVICES

(71) Applicant: Hewlett-Packard Development Company, L.P., Spring, TX (US)

(72) Inventors: Syed S. Azam, Spring, TX (US); Alexander Williams, Spring, TX (US); Dimitre Mehandjiysky, Spring, TX (US)

(73) Assignee: Hewlett-Packard Development Company, L.P., Spring, TX (US)

(21) Appl. No.: 17/042,154

(22) PCT Filed: Nov. 13, 2018
(86) PCT No.: PCT/US2018/060633

§ 371 Date: Sep. 27, 2020

(51) Int. Cl. G06F 3/02; G06F 3/023; G06F 3/0338; G05G 9/047

(52) U.S. Cl. CPC G06F 3/0219; G05G 9/047; G06F 3/0338; G06F 3/0231

(57) ABSTRACT

An input device may include a housing including a first surface comprising a plurality of alphanumeric buttons; a second surface on an obverse side of the housing as that of the first surface comprising a detachable input device selectively coupled to the second surface; and a number of coupling devices on a third surface of the housing to couple the detachable input device to the third surface of the housing.

### BACKGROUND

Computing devices and other electronics have become ubiquitous in modern life. An increasing number of electronic devices such as televisions, virtual assistant devices, and mobile computing devices, among others, are implementing or are made capable of implementing certain input devices. These peripheral devices may include mice, keyboards, external data storage devices, and extended display devices among other types of peripheral devices.

### BRIEF DESCRIPTION OF THE DRAWINGS

The accompanying drawings illustrate various examples of the principles described herein and are part of the specification. The illustrated examples are given merely for illustration, and do not limit the scope of the claims.

FIG. 1 is a block diagram of an input device according to an example of the principles described herein.

FIG. 2 is a block diagram of a computing device according to an example of the principles described herein.

FIG. 3 is a flowchart showing a method of receiving input from an input device according to an example of the principles described herein.

FIGS. 4A and 4B are perspective views of a first surface and a second surface of an input device, respectively, according to an example of the principles described herein.

FIG. 5 is a perspective view of the second surface according to an example of the principles described herein.

FIG. 6 is a perspective view of the first surface of the input device (215) according to an example of the principles described herein.

FIGS. 7A and 7B are top views of an input device according to an example of the principles described herein.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

Computing devices, through the use of various input devices, allow users to interact with the computer readable program code executed thereon. These input devices may be used to complete a myriad of any type of tasks including gaming, word processing, spreadsheet creation, and image processing, among others. In order to better facilitate this input, the input devices themselves may be formed to allow a user to relatively more conveniently provide input to the computing device.

With certain executed computer readable program code, there may be a relatively more convenient input devices to provide input than, for example, a keyboard or a mouse alone. In some examples, certain user's may be more comfortable with one type of input device while being less so with other input devices. Indeed, the comfortability of the input device may vary from one user to another. Still further, where input from multiple users is implemented to operate the executable program code such as a gaming application, a single input device will prevent a second user from providing input to the computing device.

The present specification describes an input device that provides multiple input options to a user for a computing device and/or the ability of a second user to engage, concurrently with a first user, with an executed application on a computing device.

The present specification describes an input device that includes a housing including a first surface comprising a plurality of alphanumeric buttons; a second surface on an obverse side of the housing as that of the first surface comprising a detachable input device selectively coupled to the second surface; and a number of coupling devices on a third surface of the housing to couple the detachable input device to the third surface of the housing.

The present specification also describes a computing system that includes a processor; a wireless network adapter; and an input device, that includes a housing having a keyboard formed on a first surface of the housing; and a detachable joystick formed within a second surface of the housing obverse to the first surface of the housing; wherein the joystick may be selectively folded into and out of the housing on the second surface.

The present specification further describes a method of receiving input from an input device that includes determining a detached state of a detachable input device from a first side of a keyboard housing; initiating a wireless connection between the detachable input device upon receipt of a signal that the detachable input device has been detached from the keyboard housing; and receiving input from the detachable input device concurrently with a keyboard formed on a second side of the keyboard housing, the second side being obverse to the first side of the keyboard housing.

As used in the present specification and in the appended claims, the term “obverse” is meant to be understood as a first surface facing a direction opposite a second surface. In the context of the present specification, an obverse surface of a housing of an input device may be the surface opposite to that currently being viewed.

In the present specification and in the appended claims, the term “detached state” or detached is meant to be understood as not attached or separate from another body. In the context of some examples presented herein, the detachable input device may be in a detached state when it is no longer physically coupled to, for example, from an input device or keyboard.

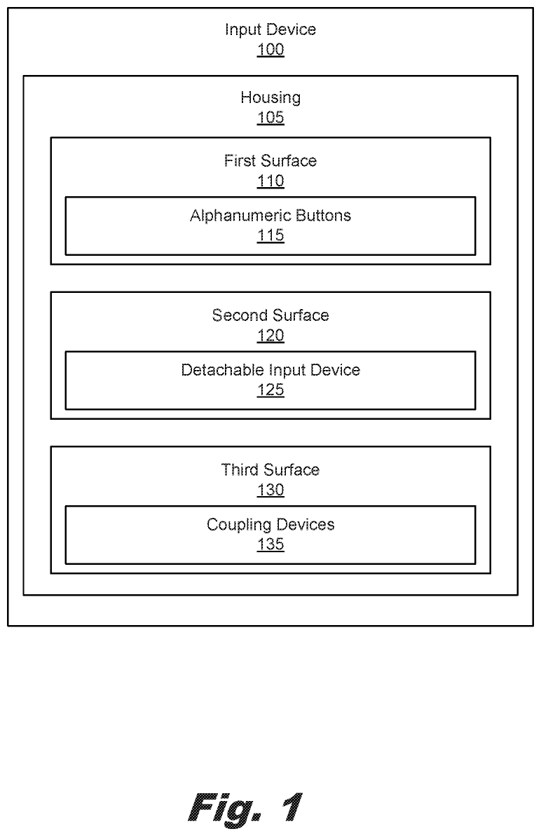

Turning now to the figures, FIG. 1 is a block diagram of an input device (100) according to an example of the principles described herein. The input device (100) may include any type of device that, via a wired or wireless connection to a processor of a computing device, provides input in the form of control signals to the processor. In any example presented herein, the processor may receive those control signals and, upon execution of computer readable program code, interpret those control signals in a manner congruent with the execution of that computer readable program code. In some examples, the computing device may include any hardware or software drivers to receive the control signals and cause those signals to be interpreted by the processor.

The input device (100) may include a housing (105). The housing (105) may be made of any type of material including composite materials, metals, and/or plastics. In an example, the housing (105) may have a number of surfaces. A first surface (110) may include a number of alphanumeric buttons (115). In an example, the first surface (110) with its alphanumeric buttons (115) may be in the form of a keyboard such as a qwerty keyboard. In this example, the alphanumeric buttons (115) may include any letter of the alphabet, any number 0 through 9, and/or any function keys, among other types of buttons that allow a user to interact with a computing device. For convenience of explanation, the present specification will be described in context of the alphanumeric buttons (115) of the first surface (110) being a qwerty keyboard.

The housing (105) may include a second surface (120). The second surface (120) may be a surface that is located on an obverse side of the housing (105). By way of example, if a user were interfacing with the alphanumeric buttons (115) of the first surface (110) and can view the first surface (110), the second surface (120) may be facing down towards a table top or other surface the input device (100) is resting on. In order to access the second surface (120), a user may flip the housing (105) over placing the first surface (110) in a position to face towards the table top.

The second surface (120) may include a detachable input device (125). In an example, the detachable input device (125) may be a joystick, an alphanumeric keyboard similar to the alphanumeric buttons (115) on the first surface (110), a mouse, and/or any other input device. For convenience in description, the detachable input devices (125) may include a pair of joysticks. Although the present specification may describe the detachable input device (125) as a joystick or pair of joysticks, the present specification contemplates that the detachable input device (125) is another type of input device described herein other than a joystick.

The detachable input device (125) may be selectively detachable from the second surface (120). In one configuration of the input device (100), a user may flip the input device (100) to expose the second surface (120) with its detachable input device (125) affixed thereto. In this example, the user may interact with the detachable input device (125) as the are attached to the second surface (120). In an example, the detachable input device (125) may be oriented away from the second surface (120) but still be attached to the second surface (120) so that the user may interact with the detachable input device (125). By way of example, where the detachable input device (125) is a joystick, when not in use the joystick may be folded into a recess of the second surface (120) still attached to the second surface (120) of the input device (100).

In an example, the detachable input device (125) may be removed from the second surface (120) allowing the user to provide input to a computing device independent of the input device (100). In this example, a wireless connection may be established between the detachable input device (125) and the input device (100) and/or computing device. The initiation of the wireless connection may be done either by the detachable input device (125), the input device (100), or the computing device. In the example where either of the computing device or input device (100) initiate the wireless connection with the detachable input device (125), the computing device and/or input device (100) may receive a signal indicating that the detachable input device (125) has been removed from the second surface (120) of the housing (105) of the input device (100). That signal may cause the wireless connection with the detachable input device (125) to be initiated. The wireless connection may be any of a Bluetooth®, a WIFI®, and a near-filed communication (NFC) wireless connection. Bluetooth® is a trademark of the Bluetooth Special Interest Group. WIFI® is a trademark of the WIFI Alliance.

In the example where the detachable input device (125) is a pair of joysticks, the joysticks may be used to adjust the ergonomics of the input device (100). In this example, the joysticks may be folded out of the second surface (120) of the input device (100) and used as stands to prop up the input device (100). This may be done while the user is accessing the alphanumeric buttons (115) on the first surface (110) of the input device (100).

In an example, configuration, multiple users may concurrently provide input to a computing device via the input device (100) described herein. In this example, the detachable input devices (125) may be removed from the second surface (120) and a plurality of users may interact with and provide input to the computing device. In the example, where the detachable input device (125) includes multiple detachable input devices (125), more than two users may interact with and provide input to the computing device. Still further, the computing device may detect other detachable input devices (125) originating from separate input devices (100) such that any number of users may interact with and provide input to the computing device. In these scenarios, any detachable input device (125) or input device (100) may be wirelessly coupled to a computing device.

In an example, a single user may switch from implementing the alphanumeric buttons (115) to implementing the detachable input device (125). In this example, the user may configure the input device (100) in one of a number of configurations. As described herein, a first configuration may include flipping the input device (100) to access and interact with the detachable input device (125) as the detachable input device (125) is coupled to the second surface (120). In a second configuration, the user may detach the detachable input device (125) from the second surface (120) and use the detachable input device (125) as the input device. In a third configuration, the user may detach the detachable input device (125) from the second surface (120) and use, concurrently, the detachable input device (125) and the alphanumeric buttons (115).

In a fourth configuration, the user may detach the detachable input device (125) from the second surface (120) and affix the detachable input device (125) to a third surface (130). In an example, the third surface (130) of the input device (100) may include a coupling device (135) to secure the detachable input device (125) to the third surface (130) of the input device (100). The coupling device may include, for example, a number of magnets, a number of rails, a number of latches, a number of screws, or any other fastening device. In an example, where the detachable input device (125) includes a plurality of detachable input devices (125) one of the pluralities of detachable input devices (125) may be affixed to the third surface (130) of the input device (100) while another detachable input device (125) is coupled to a fourth surface of the housing (105) of the input device (100). In a specific example, the third surface (130) and fourth surface are on opposite sides of the housing (105) of the input device (100). In this example, a user may affix the plurality of detachable input devices (125) on a left and right surface of the input device (100) relative to the first surface (110) with its alphanumeric buttons (115). In this configuration, the user may selectively interact with the detachable input devices (125), the alphanumeric buttons (115), or both.

In a specific example, the shape of the housing (105) of the input device (100) is cuboidal. In this example, the input device (100) may be in the shape of a qwerty keyboard with the alphanumeric buttons (115) present on a top surface facing the user, the detachable input devices (125) being couplable and/or stored on a bottom surface of the qwerty keyboard, and coupling surfaces for coupling the detachable input devices (125) thereon on the left and right side of the housing (105) of the qwerty keyboard.

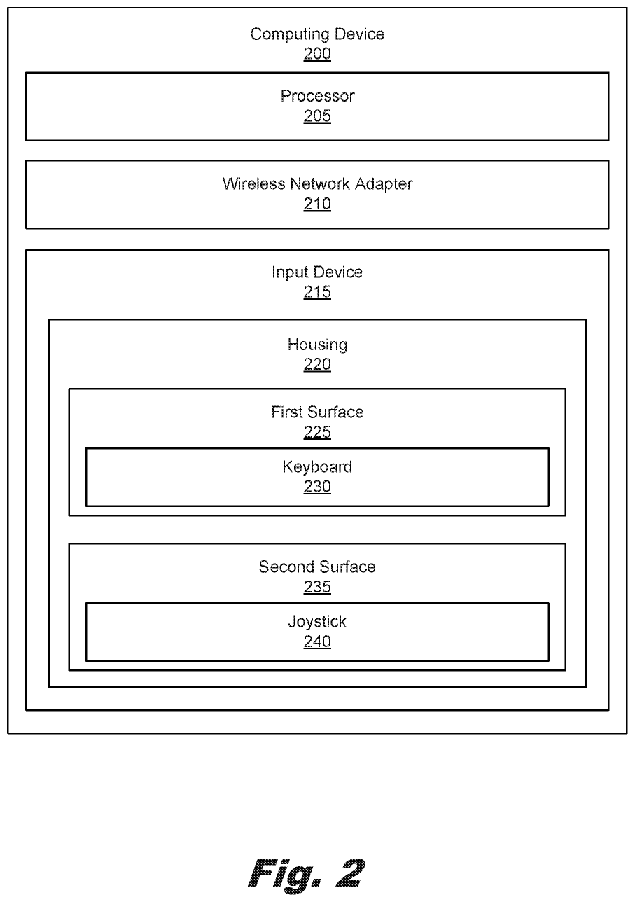

FIG. 2 is a block diagram of a computing device (200) according to an example of the principles described herein. The computing device (200) may be any type of computing device (200). Examples of computing devices (200) include servers, desktop computers, laptop computers, personal digital assistants (PDAs), mobile devices, smartphones, gaming systems, and tablets, among other computing devices (200).

To achieve its described functionality, the computing device (200) may include various hardware components. Among these hardware components may be a number of processors (205), a number of data storage device, a number of peripheral device adapters, and a number of network adapters. These hardware components may be interconnected through the use of a number of busses and/or network connections. In one example, the processors (205), data storage device, peripheral device adapters, and a network adapter may be communicatively coupled via a bus.

The processors (205) may include the hardware architecture to retrieve executable code from the data storage device and execute the executable code. The executable code may, when executed by the processor, cause the processors (205) to implement at least the functionality of determining a detached state of a detachable input device from a first side of a keyboard housing; initiating a wireless connection between the detachable input device upon receipt of a signal that the detachable input device has been detached from the keyboard housing; and receiving input from the detachable input device concurrently with a keyboard formed on a second side of the keyboard housing, the second side being obverse to the first side of the keyboard housing, according to the methods of the present specification described herein. In the course of executing code, the processors (205) may receive input from and provide output to a number of the remaining hardware units.

The data storage device may store data such as executable program code that is executed by the processors (205) or other processing device such as drivers used to interface with the input device (215) as described herein. The data storage device may specifically store computer code representing a number of applications that the processors (205) execute to implement at least the functionality described herein.

The data storage device may include various types of memory modules, including volatile and nonvolatile memory. For example, the data storage device of the present example includes Random Access Memory (RAM), Read Only Memory (ROM), and Hard Disk Drive (HDD) memory. Many other types of memory may also be utilized, and the present specification contemplates the use of many varying type(s) of memory in the data storage device as may suit a particular application of the principles described herein. In certain examples, different types of memory in the data storage device may be used for different data storage needs. For example, in certain examples the processors (205) may boot from Read Only Memory (ROM), maintain nonvolatile storage in the Hard Disk Drive (HDD) memory, and execute program code stored in Random Access Memory (RAM).

The data storage device may comprise a computer readable medium, a computer readable storage medium, or a non-transitory computer readable medium, among others. For example, the data storage device may be, but not limited to, an electronic, magnetic, optical, electromagnetic, infrared, or semiconductor system, apparatus, or device, or any suitable combination of the foregoing. More specific examples of the computer readable storage medium may include, for example, the following: an electrical connection having a number of wires, a portable computer diskette, a hard disk, a random-access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store computer usable program code for use by or in connection with an instruction execution system, apparatus, or device. In another example, a computer readable storage medium may be any non-transitory medium that can contain, or store a program for use by or in connection with an instruction execution system, apparatus, or device.

The hardware adapters in the computing device (200) enable the processors (205) to interface with various other hardware elements, external and internal to the computing device (200) such as the input device (215). For example, the peripheral device adapters may provide an interface to the input device (215) along with other input/output devices, such as, for example, a display device, a mouse, a keyboard, or the joystick (240) described herein. The peripheral device adapters may also provide access to other external devices such as an external storage device, a number of network devices such as, for example, servers, switches, and routers, client devices, other types of computing devices, and combinations thereof.

The display device may be provided to allow a user of the computing device (200) and input device (215) to interact with and implement the functionality of the computing device (200) described herein. The peripheral device adapters may also create an interface between the processors (205) and the display device, a printer, or other media output devices. The network adapter may provide an interface to other computing devices within, for example, a network, thereby enabling the transmission of data between the computing device (200) and other devices located within the network. In a specific example, the network adapter is a wireless network adapter (210) that may include a wireless connection module to communicatively couple the input device (215) to the computing device (200) so that the input provided at the input device (215) may be received and interpreted by the processors (205) of the computing device (200).

Similar to FIG. 1, the input device (215) may include a housing (220) having a first surface (225) and a second surface (235). The first surface (225), in this example, includes a keyboard (230). The keyboard (230) may be any alphanumeric keyboard and may include any other buttons for various input signals to be provided to the processors (205) of the computing device (200) as described herein. On an obverse second surface (235) relative to the first surface (225) a detachable joystick (240) or joysticks (240) may be coupled to the second surface (235). In an example, the joystick (240) may include a base portion with the base portion and joystick (240) being formed within a cavity of the second surface (235) via a coupling device such as a magnet, a screw, or any other fastener. The coupling device, however, may allow for the joystick (240) along with its base, to be selectively removed from a physical coupling to the second surface (235). This may allow a user to operate the joystick (240) independent of the keyboard (230) on the first surface (225) and, accordingly, allow input to be provided to the computing device (200) from the joystick (240) concurrently with the keyboard (230).

As described in connection with FIG. 1, the housing (220) may further include a third and/or fourth surface. The third and/or fourth surfaces may allow the joystick (240), once removed from the second surface (235), to be coupled to the third and/or fourth surface. In this configuration, the user may operate one or both of the keyboard (230) and joystick (240) to provide, concurrently, input to the processors (205) of the computing device (200).

As described herein, either or both of the keyboard (230) and joystick (240) may be communicatively coupled to the processors (205) of the computing device (200) via a wired or wireless connection. In an example, the joystick (240) may be communicatively coupled to the housing (220) of the input device (215) via a wired connection. In this example, the joystick (240) itself may still be removed from the second surface (235) of the housing (220) but be tethered to the housing (220) via a wire. The wired connection allows the input device (215) to provide input from the joystick (240) to the computing device (200) via either a wired or wireless connection.

In an example, the joystick (240) may be wirelessly coupled to the processors (205) of the processors (205) independent of whether the joystick (240) is physically coupled to the housing (220) of the input device (215). In yet another example, the joystick (240) is wirelessly coupled to the processors (205) of the computing device (200) and/or the input device (215) when uncoupled from the housing (220) but connected to the input device (215) (and the processors (205) of the computing device (200)) via a wired connection whenever coupled to any surface of the housing (220). Thus, in this example, the second surface (235), the third surface, and/or fourth surface may each include both a physical coupling device as well as an electrical coupling device to physically couple and electrically couple the joystick (240) to these surfaces, respectively.

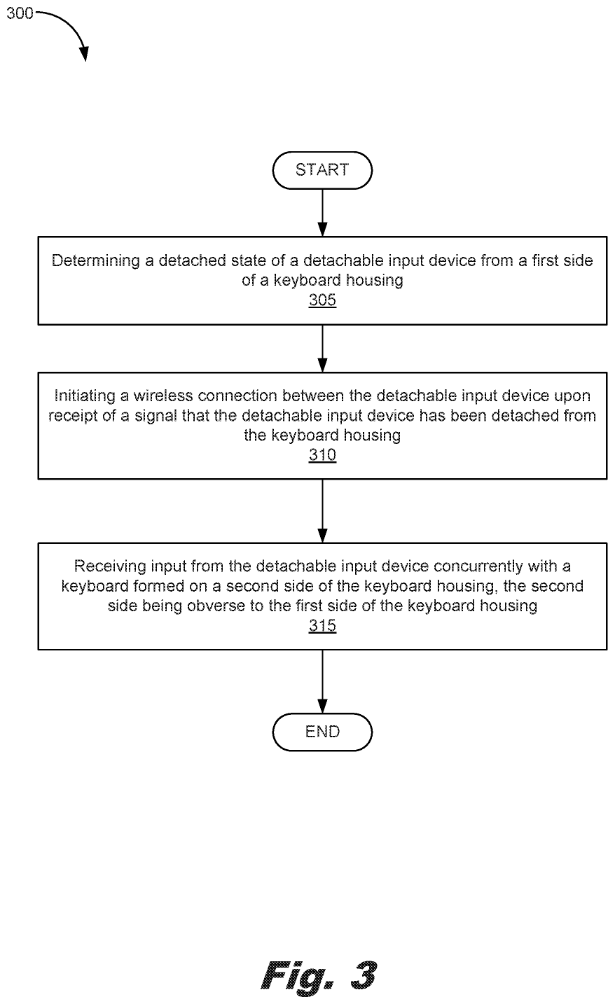

FIG. 3 is a flowchart showing a method (300) of receiving input from an input device according to an example of the principles described herein. The method (300) may include determining (305) a detached state of a detachable input device from a first side of a keyboard housing. In this example, the housing (220) of the input device (215) may include a mechanical and/or electrical sensor that senses whether the joystick (240) is coupled to the housing (220) of the input device (215) at either the second surface (235), third surface, and/or fourth surface.

The method (300) may include initiating (310) a wireless connection between the detachable input device (125, 240) upon receipt of a signal that the detachable input device (125, 240) has been detached from the keyboard housing (220). As described herein, the initiation of the wireless connection to the joystick (240) or other detachable input device (125) may be accomplished by execution of computer readable program code by the processors (205) of the computing device (200). In another example, the detachable input device (125, 240) may be wirelessly coupled to the input device (215) itself and, in this example, the input device (215) may include a wireless network module to initiate (310) the wireless connection.

The method (300) may further include receiving (315) input from the detachable input device (125, 240) concurrently with a keyboard (230) formed on a second side of the keyboard housing (220), the second side being obverse to the first side of the keyboard housing (220). In this example, a single user or multiple users may control one or more of the detachable input devices (125, 240) and keyboard (230) with the processors (205) of the computing device (200) receiving (315) input from both of these input source concurrently. This provides, for a single user, multiple ways of providing input to the processors (205). In the example where, multiple potential users may operate the detachable input device (125, 240) and keyboard (230), multiple users may engage in a cooperative activity on the computing device (200). An example of such a cooperative activity may be a gaming activity via execution of a gaming application on the computing device (200).

Via the use of the input device (100, 215) described herein, a user may have increased ability provide input to a computing device. The user may, from the same input device, have an increased ability to provide input to a computing device by removing the detachable input devices and interfacing with those devices rather than a keyboard alone. Also, the user may include other users while interfacing with the computing device such that a first user may implement the keyboard while a second user implements the joystick. In this way, multiple users may concurrently interact with the computing device by providing input from each of their respective input devices.

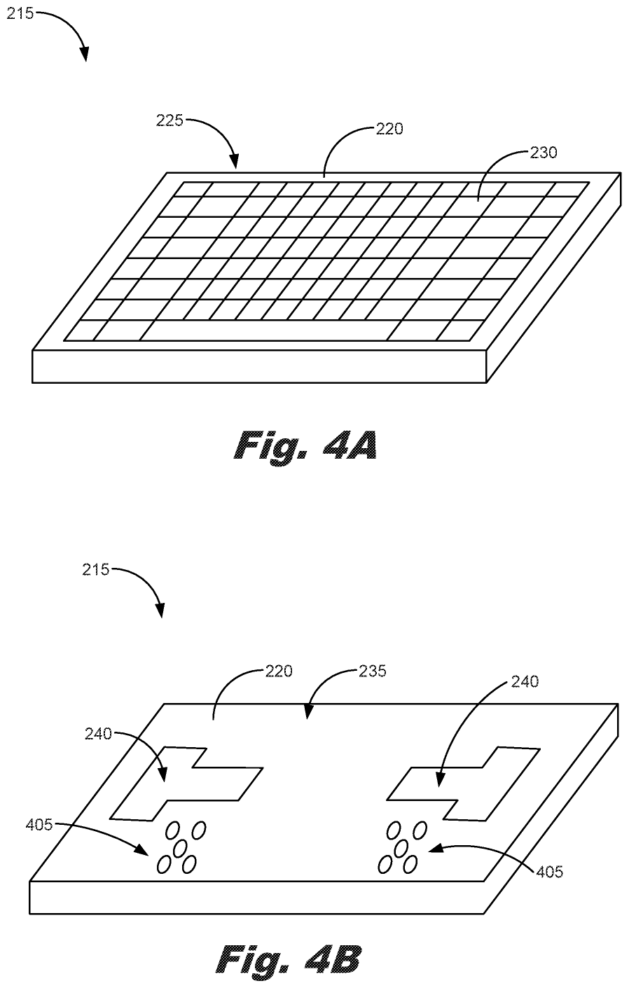

FIGS. 4A and 4B are perspective views of a first surface (225) and a second surface (235) of an input device (215), respectively, according to an example of the principles described herein. As described herein, the first surface (225) includes a keyboard (230) that includes any number of alphanumeric and functional keys. Additionally, the keyboard (230) may be formed within the housing (220) of the input device (215). On the second surface (235), obverse to the first surface (225), a plurality of joysticks (240) may be formed within the housing (220) of the input device (215). In an example, a number of buttons (405) may be included next to the joysticks (240). In the configuration shown in FIGS. 4A and 4B, the user may flip the input device (215) over in order to access the joysticks (240).

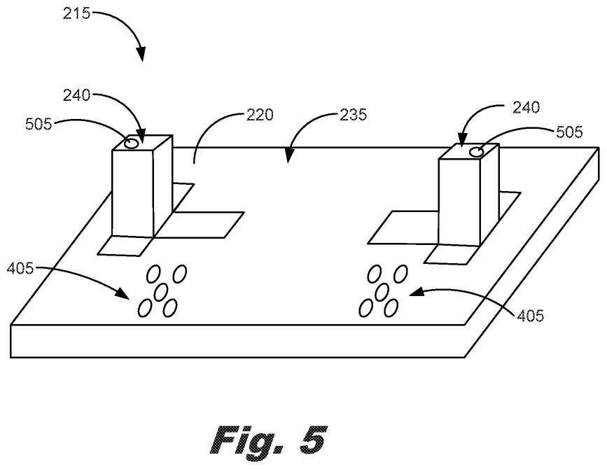

FIG. 5 is a perspective view of the second surface (235) according to an example of the principles described herein. In this example, handles of the joysticks (240) have been moved out from their recesses but still remain coupled to the housing (220) of the input device (215). In this configuration, the joysticks (240) may be manipulated by the user to provide input to, for example, a processor (205) of a computing device (200). Additionally, in this configuration, the user is prevented from using the keyboard (230) on the obverse side of the housing (220).

In an example, the joysticks (240) may each include a pad (505). The pads (505) may be used to rest the input device (215) on a surface. In this example, the first surface (225) may be oriented upwards so that a top portion of the handles of the joysticks (240) touch the surface the input device (215) is resting on. As described herein, the joysticks (240) may serve as stands to prop up the input device (215) when the user is accessing the keyboard (230).

In any example presented herein, the input device (215) may include an accelerometer to determine which of the first surface (225) or second surface (235) is facing up from a surface the input device (215) is resting on. In an example, the accelerometer may prevent input from the keyboard (230) when, for example, the housing (220) has been so oriented so that the keyboard (230) is not accessible by a user.

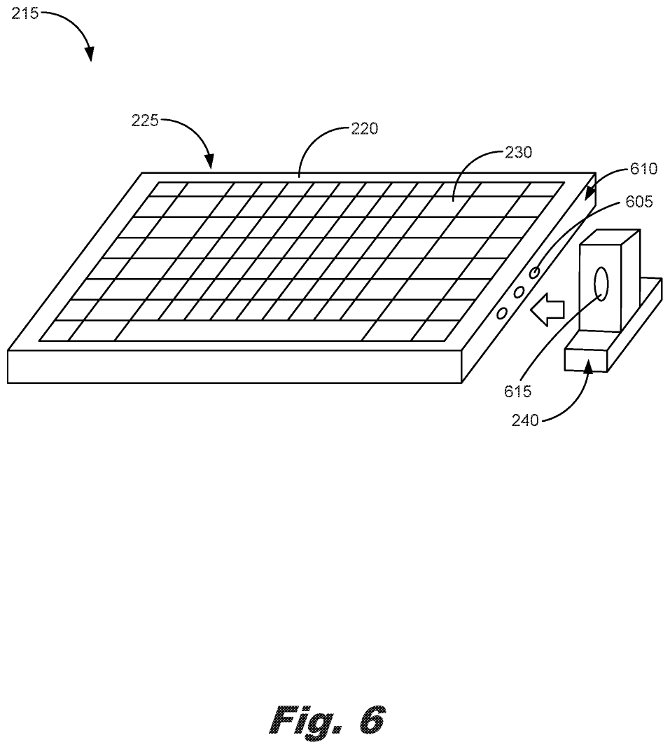

FIG. 6 is a perspective view of the first surface (225) of the input device (215) according to an example of the principles described herein. In this example, the joystick (240) has been removed from the second surface (235) of the input device (215) and the input device (215) has been flipped over to reveal the keyboard (230). In an example, the user or a plurality of users may use the keyboard (230) and joystick (240) independent of each other. In this example, the input from both the joystick (240) and keyboard (230) may be sent, concurrently, to a processor (205) of the computing device (200). In an example, the input device (215) may have the keyboard (230) facing down towards a surface of, for example, a desk. In this configuration, the attached and detached may selectively provide input to a computing device. Consequently, regardless of their state (attached or detached), the joysticks (240) may provide input to a computing device either via a wired connection or wireless connection.

FIG. 6 also shows a number of contact points (605) that allows the joystick (240) to be coupled to a third surface (610) of the housing (220). The contact points (605) may include coupling devices that couple the joystick (240) to the third surface (610) physically and/or electrically. In the example where the contact points (605) electrically couple the joystick (240) to the third surface (610), a battery within the joystick (240) may be charged and a wired connection between the joystick (240) and the input device (215) may be formed. Without the coupling of the joystick (240) to the third surface (610), the joystick (240) may operate on the battery power and may transmit input data to the input device (215) and/or processors (205) of the computing device (200). In an example, a second joystick (240) may be similarly coupled to a fourth surface opposite the third surface (610) so as to present the joysticks (240) on a left and right side of the keyboard (230). With any joystick (240) coupled to the third surface (610) via the contact points (605), a user may provide input to the computing device (200) using both the joystick (240) and the keyboard (230). Alternatively, the keyboard (230) may be placed face down and the joysticks (240) may be coupled to the third surface (610) and fourth surface allowing the user to use the joysticks (240) as input devices without the keyboard (230) being used.

In any example presented herein, the joystick (240) may include a biometric sensor (615). The biometric sensor (615) may be placed on the joystick (240) so as to come in contact with a user. In an example, the biometric sensor (615) may be a fingerprint sensor. During operation, the biometric sensor (615) may determine the user's identity and provide access to certain applications executed on the computing device (200) based on that identification. Additionally, personal information may be accessed and manipulated by the user when sensed biometric data from the biometric sensor (615) indicates that the user has authority, via the biometric data, to access that data.

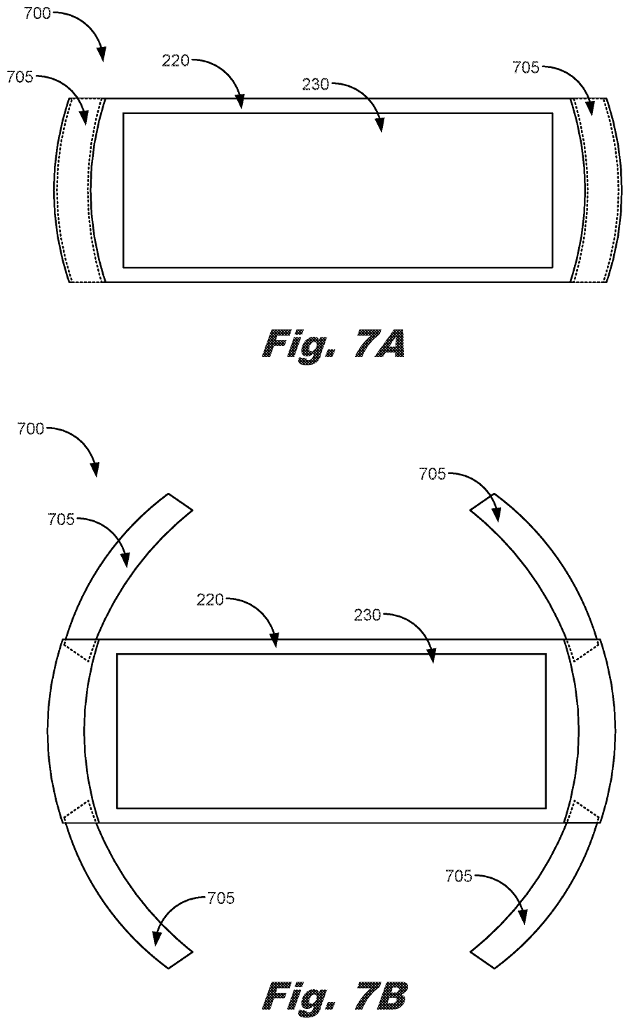

FIGS. 7A and 7B are top views of an input device (700) according to an example of the principles described herein. The input device (700), in this example, may include an integrated input device (705). The integrated input device (705) may be formed into a number of edges of the input device (700) to be selectively retracted therefrom. In an example, the integrated input device (705) may be spring loaded so that upon activation of a retraction button, the integrated input device (705) extends out of the edges of the input device (700). The extension of the integrated input device (705) may modify the form of the input device (700) into, for example, a steering wheel form.

In an example, the integrated input device (705) and/or the input device (700) may include an accelerometer and/or gyroscopic sensor. The accelerometer and/or gyroscopic sensor may determine the physical location of the input device (700) within a 3D space and/or the movement of the input device (700) in that space. In a specific example, the input device (700) in its deployed and steering wheel configuration may be used in connection with a gaming application being executed on a computing device.

Aspects of the present system and method are described herein with reference to flowchart illustrations and/or block diagrams of methods, apparatus (systems) and computer program products according to examples of the principles described herein. Each block of the flowchart illustrations and block diagrams, and combinations of blocks in the flowchart illustrations and block diagrams, may be implemented by computer usable program code. The computer usable program code may be provided to a processor of a general-purpose computer, special purpose computer, or other programmable data processing apparatus to produce a machine, such that the computer usable program code, when executed via, for example, the processor (205) of the computing device (200) or other programmable data processing apparatus, implement the functions or acts specified in the flowchart and/or block diagram block or blocks. In one example, the computer usable program code may be embodied within a computer readable storage medium; the computer readable storage medium being part of the computer program product. In one example, the computer readable storage medium is a non-transitory computer readable medium.

The specification and figures describe an input device used with a computing device. The input device provides a user with the ability to switch from one form of input device to another and/or share input controls with another user. In an example, the user may select how the user is to provide input based on whether the user uses the detachable input device or the keyboard as described. The described detachable input device may be detached from the housing of the input device and a wireless connection may be initiated when a sensor has sensed the detachment. The input may, therefor, be received by a computing device from both the keyboard and the detachable input device concurrently allowing for multiple users to interact with the computing device concurrently. In an example, the user may remove the detachable input device and recouple it to the housing of the input device such that both the keyboard and detachable input device are used concurrently by the user. When not in use, the detachable input device may be stored on a side of the input device obverse to the side of the housing of the input device the keyboard is formed on.

The preceding description has been presented to illustrate and describe examples of the principles described. This description is not intended to be exhaustive or to limit these principles to any precise form disclosed. Many modifications and variations are possible in light of the above teaching.

What is claimed is:

1. An input device, comprising:
a housing comprising:
a first surface comprising a plurality of alphanumeric buttons;
a second surface on an obverse side of the housing as that of the first surface comprising a detachable input device selectively coupled to the second surface; and
a number of coupling devices on a third surface of the housing to couple the detachable input device to the third surface of the housing.

2. The input device of claim 1, comprising an accelerometer that determines which of the first and second surface are upright and a processor to deactivate input from one of the alphanumeric buttons or detachable input device when it is determined that either the alphanumeric buttons or detachable input device are positioned opposite the upright surface.

3. The input device of claim 1, further comprising a controller to determine the coupled state of the detachable input device.

4. The input device of claim 3, wherein, upon detection that the detachable input device is detached from the second surface of the housing, initiate a wireless connection between the input device and detachable input device.

5. The input device of claim 3, wherein, upon detection that the detachable input device is detached from the second surface of the housing, sends a signal to a computing device to cause the computing device to be communicatively coupled to the computing device.

6. The input device of claim 1, wherein the detachable input device, when coupled to the second surface of the input device, serve as a standing device to prop up the input device.

7. The input device of claim 1, wherein the alphanumeric buttons and detachable input device provide input to a computing device concurrently.

8. The input device of claim 1, wherein the detachable input device comprises a biometric sensor to determine the identity of a user interfacing with the detachable input device.

9. A computing system, comprising:
a processor;
a wireless network adapter; and
an input device, comprising:
a housing having a keyboard formed on a first surface of the housing; and
a detachable joystick formed within a second surface of the housing obverse to the first surface of the housing;
wherein the joystick may be selectively folded into and out of the housing on the second surface.

10. The computing system of claim 9, wherein the processor receives input from the keyboard and the detachable joystick concurrently.

11. The computing system of claim 9, wherein the processor, via the wireless network adapter, establishes a wireless connection with the detachable joystick upon detection that the joystick is detached from the input device.

12. The computing system of claim 9, wherein the detachable joystick comprises a biometric reader to read biometric data from a user.

13. A method of receiving input from an input device, comprising:
determining a detached state of a detachable input device from a first side of a keyboard housing;
initiating a wireless connection between the detachable input device upon receipt of a signal that the detachable input device has been detached from the keyboard housing; and
receiving input from the detachable input device concurrently with a keyboard formed on a second side of the keyboard housing, the second side being obverse to the first side of the keyboard housing.

14. The method of claim 13, comprising initiating a wired communication upon detection of the attachment of the detachable input device to the keyboard housing.

15. The method of claim 13, comprising indicating that the keyboard and detachable input device are being operated by distinct users.
